(19) United States
(12) Patent Application Publication
(10) Pub. No.: US 2015/0253996 A1
(43) Pub. Date: Sep. 10, 2015

(54) ACCESS CONTROL METHOD AND DATA STORAGE DEVICE

(71) Applicant: Kabushiki Kaisha Toshiba, Minato-ku (JP)

(72) Inventors: Hidetaka NAGASHIMA, Ome-shi (JP); Hiroko OKABAYASHI, Tachikawa-shi (JP)

(73) Assignee: Kabushiki Kaisha Toshiba, Minato-ku (JP)

(21) Appl. No.: 14/309,151

(22) Filed: Jun. 19, 2014

Related U.S. Application Data
(60) Provisional application No. 61/948,432, filed on Mar. 5, 2014.

(51) Int. Cl. G06F 3/06

(52) U.S. Cl. CPC G06F 3/065; G06F 3/0604; G06F 3/0679

(57) ABSTRACT

In an access control method of an embodiment, a first arithmetic unit writes a file in a first non-volatile storage region that can be accessed by the first arithmetic unit and cannot be accessed by a second arithmetic unit. Then, when the first arithmetic unit is started next time, the first arithmetic unit copies the file from the first non-volatile storage region to a second non-volatile storage region before the second arithmetic unit recognizes the second non-volatile storage region. Further, after the copy, the second arithmetic unit recognizes the second non-volatile storage region.

### CROSS-REFERENCE TO RELATED APPLICATIONS

This application is based upon and claims the benefit of priority from U.S. Provisional Application No. 61/948,432, filed on Mar. 5, 2014; the entire contents of which are incorporated herein by reference.

### FIELD

The present embodiment relates to an access control method and a data storage device.

### BACKGROUND

A data storage device, such as a memory card, is used with a host, such as a digital camera. When the data storage device is connected with a host, a host central processing unit (CPU) included in the host and a sub CPU included in the data storage device can access a data storage region in the data storage device.

Conventionally, in such a data storage device, a secret region that is inaccessible from the host CPU is created in the data storage region in advance, and this allows the sub CPU to write data in the secret region even during an operation of the host CPU.

However, when the host CPU recognizes a file system of the data storage region, information of the file system is cached in the host CPU. In such a case, when the sub CPU writes data in the data storage region (a normal region other than the secret region), inconsistency is caused between information of the file system of the data storage region and information of the file system cached in the host CPU, and thus the file systems may be destroyed.

Therefore, before the sub CPU writes data in the normal region, the sub CPU notifies the host CPU that writing data to the normal region is starting, and stops an access from the host CPU. Then, after the sub CPU completes the writing the data, the sub CPU notifies the host CPU of the completion of the writing the data, and this causes the host CPU to re-read the file system. If processing of the host CPU is not changed in this way, the sub CPU has not been able to write data in the normal region. Therefore, it is desired to easily perform data access control with respect to the data storage region.

### BRIEF DESCRIPTION OF THE DRAWINGS

FIG. 1 is a diagram illustrating a configuration of an information storage system according to an embodiment;

FIG. 2 is a diagram illustrating a configuration of a memory card according to an embodiment;

FIG. 3 is a diagram illustrating a configuration of a NAND-type flash memory (hereinafter, called NAND);

FIG. 4 is a diagram illustrating a processing procedure of an information storage system according to an embodiment;

FIG. 5 is a diagram for describing processing of writing a file in a secret region;

FIG. 6 is a diagram for describing processing of copying a file in a normal region;

FIG. 7 is a diagram for describing processing of deleting a file in a secret region;

FIG. 8 is a diagram for describing a file configuration example in a normal region and a secret region;

FIG. 9 is a diagram for describing an FAT;

FIG. 10 is a diagram for describing processing of copying a file using processing of changing logical addresses; and

FIG. 11 is a diagram for describing processing of copying a file using processing of changing allocation of a normal region and a secret region.

### DETAILED DESCRIPTION

According to the present embodiment, an access control method is provided. In the access control method, a first arithmetic unit writes a file in a first non-volatile storage region that can be accessed by the first arithmetic unit and cannot be accessed by a second arithmetic unit. Then, when the first arithmetic unit is started next time, the first arithmetic unit copies the file from the first non-volatile storage region to a second non-volatile storage region before the second arithmetic unit recognizes the second non-volatile storage region. Further, after the copy, the second arithmetic unit recognizes the second non-volatile storage region.

Hereinafter, an access control method and a data storage device according to embodiments will be described in detail with reference to the appended drawings. Note that the present invention is not limited by the embodiments.

### Embodiment

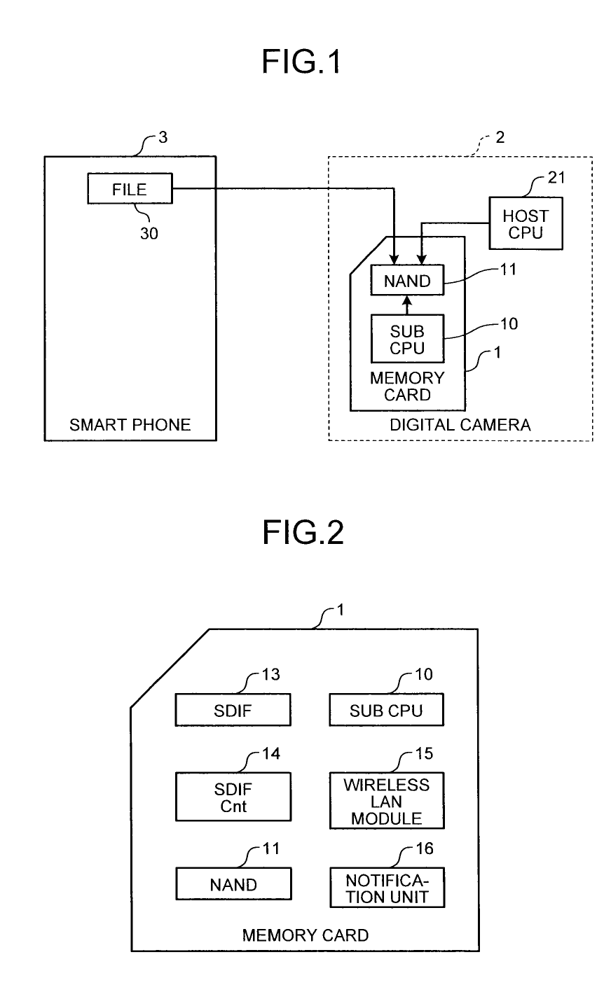

FIG. 1 is a diagram illustrating a configuration of an information storage system (a data storage system) according to an embodiment. The information storage system includes a host (here, a digital camera 2), a data storage device (here, a memory card 1), and a data transmission device (here, a smartphone 3). The information storage system is a system that stores and transfers data (a file 30) by accesses from a plurality of central processing units (CPUs) to the memory card 1. Each CPU in the information storage system executes access control of the file 30.

In the present embodiment, a case in which the smartphone 3 transmits the file 30, such as an image, to the memory card 1, and the digital camera 2 accesses the file 30 in the memory card 1 will be described.

The host 2 includes a host (main) CPU 21, and the host CPU 21 controls an access to the memory card 1. The smartphone 3 has a function to transmit the file 30 to the memory card 1.

The memory card 1 becomes accessible by the digital camera 2 by being connected to the digital camera 2. Further, the memory card 1 has a wireless communication function, and receives the file 30 transmitted from the smartphone 3.

The memory card 1 includes a NAND 11 that is a NAND module and a sub CPU 10. The NAND 11 stores the file 30 transmitted from the smartphone 3. The NAND 11 is accessed by the sub CPU 10 and the host CPU 21.

In the memory card 1 of the present embodiment, a secret region 52 described below is set in the data storage region. The secret region 52 is a region accessible by the sub CPU 10, and not accessible by the host CPU 21. The file 30 transmitted from the smartphone 3 is temporarily stored in the secret region 52, and is then transferred to a region (a normal region 51 described below) accessible by the host CPU 21 and the sub CPU 10 at a predetermined timing.

Note that, in the present embodiment, a case in which the data transmission device that transmits data to the data storage device 1 is the smartphone 3 is described. However, the data transmission device may be a device other than the smartphone 3, such as a personal computer (PC) or a mobile phone. Further, the data storage device may be a device other than the memory card 1. Further, the host may be a device other than the digital camera 2.

FIG. 2 is a diagram illustrating a configuration of a memory card according to the embodiment. Here, a case in which the memory card 1 is an SD memory card with a wireless function will be described. The memory card 1 includes the sub CPU 10, the NAND 11, an SD interface (SDIF) 13, an SD interface controller (SDIFCnt) 14, a wireless LAN module 15, and a notification unit 16. Note that the wireless LAN module 15 may be arranged in the sub CPU 10.

The memory card 1 is connected with the host CPU 21 through the SDIF 13, and is recognized by the digital camera 2 similarly to a conventional SD memory card. The SDIFCnt 14 controls the SDIF 13.

The wireless LAN module 15 performs wireless communication with the smartphone 3. The memory card 1 is connected with the digital camera 2, and the power is supplied to the memory card 1, so that the wireless LAN module 15 is automatically started.

The NAND 11 is configured from a NAND-type flash memory. The NAND 11 is formatted in a file allocation table (FAT) file system. The secret region 52 that cannot be recognized by the host CPU 21 is created in the NAND 11 in advance.

The sub CPU 10 has a server function, such as a hypertext transfer protocol (HTTP) server function. The HTTP server function has a function to upload the file 30 to the NAND 11.

The notification unit 16 notifies the user of a processing state of writing when the file 30 is written in the NAND 11. At a timing when reception of the file 30 from the smartphone 3 has been completed, the notification unit 16 notifies the user of the completion of reception, for example. The notification unit 16 is at least one of a light output device, such as a light emitting diode (LED), a vibration generation device that generates a vibration, a sound output device that outputs a sound, and the like.

Note that another non-volatile memory (semiconductor memory) or the like may be used instead of the NAND 11. The NAND 11 stores the file 30 transmitted from the smartphone 3 and data acquired in the digital camera 2 (image data, and the like) as user data.

The sub CPU 10 performs access control to the NAND 11. Further, the sub CPU 10 controls the notification unit 16 and the wireless LAN module 15. Note that the memory card 1 may include a wired module that performs communication with the smartphone 3.

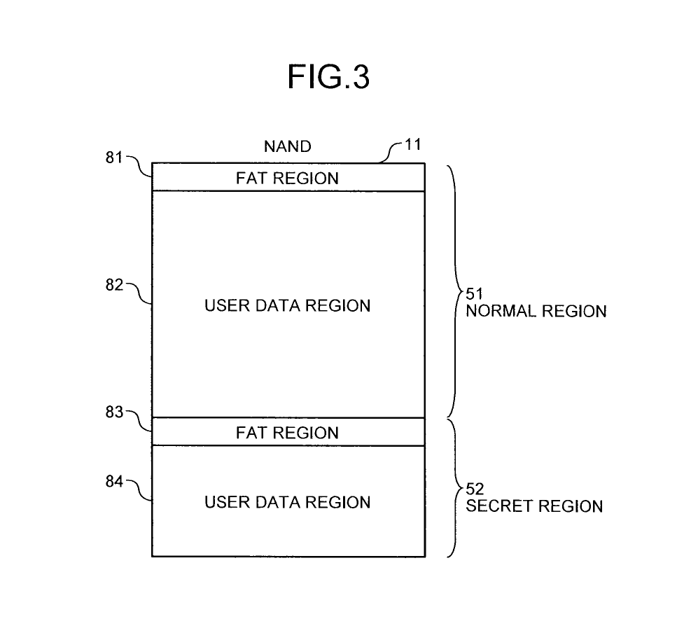

FIG. 3 is a diagram illustrating a configuration of a NAND. The NAND 11 includes the normal region 51 accessible by both of the sub CPU 10 and the host CPU 21, and the secret region 52 accessible by the sub CPU 10 but unrecognizable (inaccessible) by the host CPU 21. In this way, the normal region 51 and the secret region 52 are allocated to the NAND 11 that is a single (the same) storage region. Note that the host CPU 21 does not access the normal region 51 as long as a device driver in the sub CPU 10 returns BUSY to an initialization command (ACMD 41) from the host CPU.

The secret region 52 includes an FAT region 83 that stores an FAT of the secret region 52, and a user data region 84 that stores the file 30 transmitted from the smartphone 3, and the like. The secret region 52 is a non-volatile storage region accessible by the sub CPU 10. The FAT of the secret region 52 includes information that indicates a storage location of data in the secret region 52, and the like.

The normal region 51 is a non-volatile storage region accessible by the sub CPU 10, and also accessible by the host CPU 21 when having been recognized by the host CPU 21. The normal region 51 includes an FAT region 81 that stores an FAT of the normal region 51, and a user data region 82 that stores the file 30 transmitted from the smartphone 3 and data acquired in the digital camera 2. The FAT of the normal region 51 includes information that indicates a storage location of data in the normal region 51, and the like.

In the present embodiment, after the memory card 1 is connected to the digital camera 2, the file 30 in the secret region 52 is transferred (copied) to the normal region 51 before the NAND 11 is recognized by the host CPU 21. The sub CPU 10 of the present embodiment has a function to control whether the host CPU 21 recognize/does not recognize the normal region 51 (control switching of recognizing and not recognizing). For example, the sub CPU 10 causes the host CPU 21 not to recognize the normal region 51 until the file 30 in the secret region 52 is transferred to the normal region 51, and allows the host CPU 21 to recognize the normal region 51 after the transfer of the file 30. Therefore, the host CPU 21 recognizes the normal region 51 and becomes able to access the normal region 51 after the transfer of the file 30.

Note that the size of the secret region 52 is not limited to a fixed size, and may be changed according to the size of the file 30. For example, a range that can store data having a predetermined size is secured in the secret region 52 at any timing. In this case, when the file 30 is stored in the secret region 52, a region according to the size of the file 30 is added to the secret region 52.

Further, data (the file 30, and the like) in the NAND 11 is managed using a management table (logical/physical table) in which a logical address and a physical address are associated with each other, or the like. In the logical/physical table, which of the normal region 51 and the secret region 52 the data in the NAND 11 belongs to is managed. The logical/physical table may be stored in the NAND 11, or may be stored in a storage device different from the NAND 11.

The logical address is an address used by the digital camera 2 for managing data in the NAND 11. An access from the digital camera 2 to the memory card 1 is performed based on a logical address. The physical address is an address that indicates a physical region in the NAND 11. The sub CPU 10 accesses the NAND 11 using the physical address according to an access request from the digital camera 2.

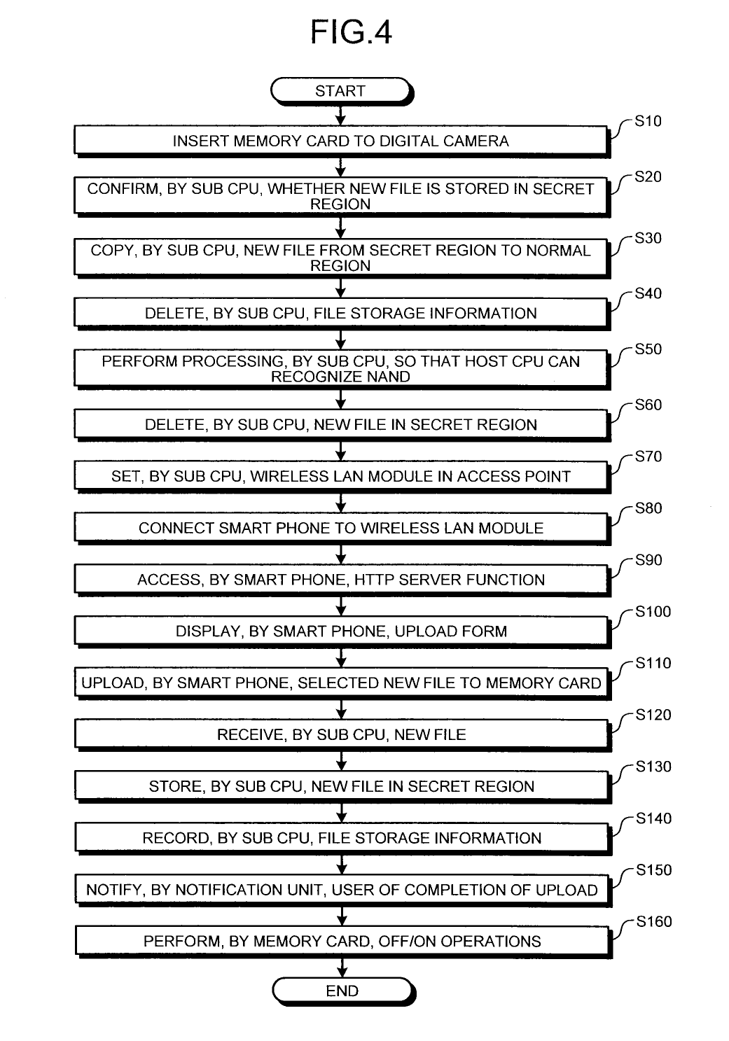

FIG. 4 is a diagram illustrating a processing procedure of the information storage system according to the embodiment. The memory card 1 is inserted to the digital camera 2 (step S10). Thus, the power is supplied to the memory card 1, and the sub CPU 10 of the memory card 1 is started.

The sub CPU 10 reads out file storage information in the secret region 52 (user data region 84). The file storage information is stored in an FAT 42 described below, for example. The file storage information includes information (a file ID, and the like) related to existence or not existence of the file 30 stored in the secret region 52, and information (an address) related to a stored location of the file 30.

The sub CPU 10 confirms whether a new file 30 is stored in the secret region 52 based on the file storage information (step S20). When information of the new file 30 is stored in the file storage information, the sub CPU 10 detects that the file 30 has been newly stored.

When the new file 30 is stored in the secret region 52, the sub CPU 10 copies the file 30 from the secret region 52 to the normal region 51 (user data region 82) (step S30). Following that, the sub CPU 10 deletes the file storage information that indicates the new file 30 has been stored from a specific file in the secret region 52 (step S40). In this way, the memory card 1 executes the processing of steps S20 to S40 while being recognized by the digital camera 2 as in a busy state.

The sub CPU 10 performs processing so that the host CPU 21 can recognize the NAND 11 (step S50). To be specific, a device driver of the sub CPU 10 returns READY to the initialization command (ACMD 41) from the host CPU. This enables the host CPU 21 to recognize the normal region 51 of the NAND 11. The sub CPU 10 deletes the new file 30 (an original file that has been copied to the normal region 51) in the secret region 52 (step S60). During steps S10 to S40, the host CPU 21 cannot access the NAND 11, and thus inconsistency is not caused in the file system.

When the power is supplied to the memory card 1, the sub CPU 10 sets the wireless LAN module 15 in an access point (step S70). This enables the wireless LAN module 15 to be operated as an access point.

The smartphone 3 is connected to the wireless LAN module 15 as a station (step S80). When there is a new file 30 (a file to be uploaded to the memory card 1) in the smartphone 3, the smartphone 3 accesses the HTTP server function of the sub CPU 10 using a browser (step S90). The sub CPU 10 transmits an upload form to the smartphone 3 using the HTTP server function. The smartphone 3 then displays the upload form in the browser, and displays a file and a new file 30 in the smartphone 3 as candidates of files to be uploaded (step S100).

Then, when a new file 30 to be uploaded is selected by the user from among the files displayed as the candidates of files to be uploaded, the smartphone 3 uploads the selected new file 30 to the memory card 1 (step S110).

This enables the sub CPU 10 to receive the new file 30 by the HTTP processing (step S120). The sub CPU 10 then stores the received new file 30 in the secret region 52 by the HTTP processing (step S130).

Further, the sub CPU 10 records file storage information in a specific file in the secret region 52 (step S140). Further, the sub CPU 10 causes the notification unit 16 to notify the user of completion of upload. This enables the notification unit 16 notifies the user of the completion of upload (step S150). The notification unit 16 notifies the user of the completion of upload using an LED, a vibration, a sound, or the like.

Following that, the sub CPU 10 executes an operation to turn OFF a detection signal used by the host CPU 21 and the sub CPU 10 for detecting insertion of the memory card 1 (connection between the memory card 1 and the digital camera 2) and an operation to turn ON the detection signal (step S160). The sub CPU 10 may execute the OFF/ON operations of a detection signal by a mechanical method, or may execute the OFF/ON operations of a detection signal by an electrical method. The sub CPU 10 executes the OFF/ON operations of a detection signal by executing an operation to turn OFF a card detect switch and an operation to turn ON the card detect switch, for example. Further, the sub CPU 10 may execute the OFF/ON operations of a detection signal by executing cut-off and connection of the power supplied from the digital camera 2 to the memory card 1, for example.

The memory card 1 becomes in the state where step S10 has been performed (the state where the sub CPU 10 has been re-started) by executing the OFF/ON operations of a detection signal. The OFF operation of a detection signal is an operation to set the detection signal of the memory card 1 to a state indicating the memory card 1 has been removed from the host, such as the digital camera 2. Meanwhile, the ON operation of a detection signal is an operation to set the detection signal of the memory card 1 to a state indicating the memory card 1 has been connected to the host, such as the digital camera 2.

In a state where the memory card 1 is connected to the digital camera 2, the sub CPU 10 causes the state to be a state that is the same as the state where the memory card 1 is removed from the digital camera 2 and is re-connected to the digital camera 2 by executing the OFF operation and the ON operation of a detection signal in succession. That is, the memory card 1 voluntarily performs an operation corresponding to removal and insertion of the memory card 1. Accordingly, transfer of the file 30 from the secret region 52 to the normal region 51 is performed (steps S20 to S40), and then the host CPU 21 becomes able to access the normal region 51 (step S50). As a result, the file 30 uploaded by the smartphone 3 becomes available by the digital camera 2.

As described above, the timing at which the sub CPU 10 accesses the normal region 51 is a timing at which the host CPU 21 cannot access the normal region 51. Further, the timing at which the host CPU 21 accesses the normal region 51 is a timing at which the sub CPU 10 does not access the normal region 51. Therefore, inconsistency is not caused in the file system of the normal region 51 accessed by the host CPU 21 and the sub CPU 10 access.

Note that the notification unit 16 may perform notification processing to the user at any timing. For example, the notification unit 16 may execute the notification processing to the user at a timing of completion of transfer of the file 30 from the secret region 52 to the normal region 51. In other words, the notification unit 16 may notify the user of the completion of writing the file 30.

Further, the notification unit 16 may continue the notification processing while the file 30 is being received from the smartphone 3. Further, the notification unit 16 may continue the notification processing while the file 30 is being transferred from the secret region 52 to the normal region 51. In other words, the notification unit 16 may notify the user of during reception of the file 30 or during writing to the normal region 51.

Further, the timings at which the file 30 is deleted and the file storage information is deleted from the secret region 52 may be any timings as long as they are after step S30.

Further, the smartphone 3 may upload a new file 30 to the memory card 1 according to an instruction from the user, or may automatically upload a new file 30 to be uploaded to the memory card 1 at a timing at which the new file 30 becomes uploadable.

Further, the memory card 1 may execute the processing of steps S20 to S60 during initialization processing of the memory card 1, or may execute the processing before the initialization processing. This initialization processing is processing for starting an access from the digital camera 2 to the memory card 1. At the initialization processing, construction of the logical/physical table, detection of a defective region in the NAND 11, and the like are executed by the host CPU 21.

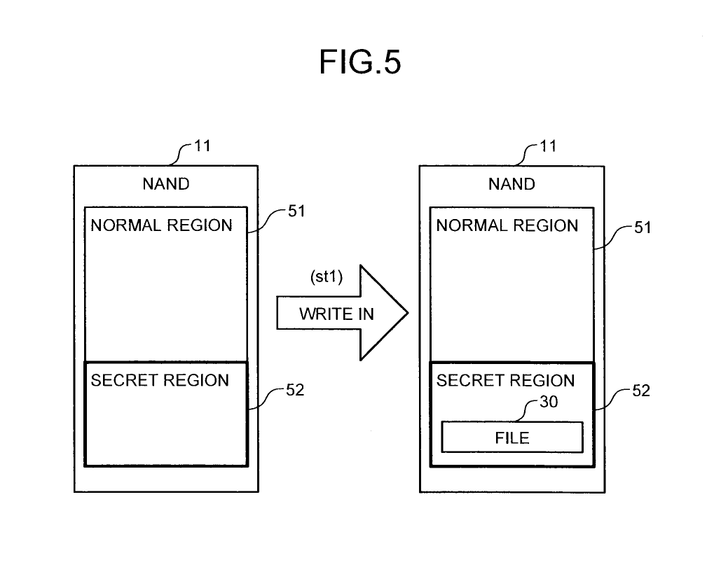

FIG. 5 is a diagram for describing processing of writing a file in a secret region. Note that, in FIGS. 5, 6, 7, and 9, illustration of the FAT regions 81 and 83 is omitted. After the memory card 1 is connected to the digital camera 2, the wireless LAN module 15 is operated as an access point. Following that, the memory card 1 receives the file 30 transmitted from the smartphone 3. Accordingly, the file 30 is written in the secret region 52 (st1).

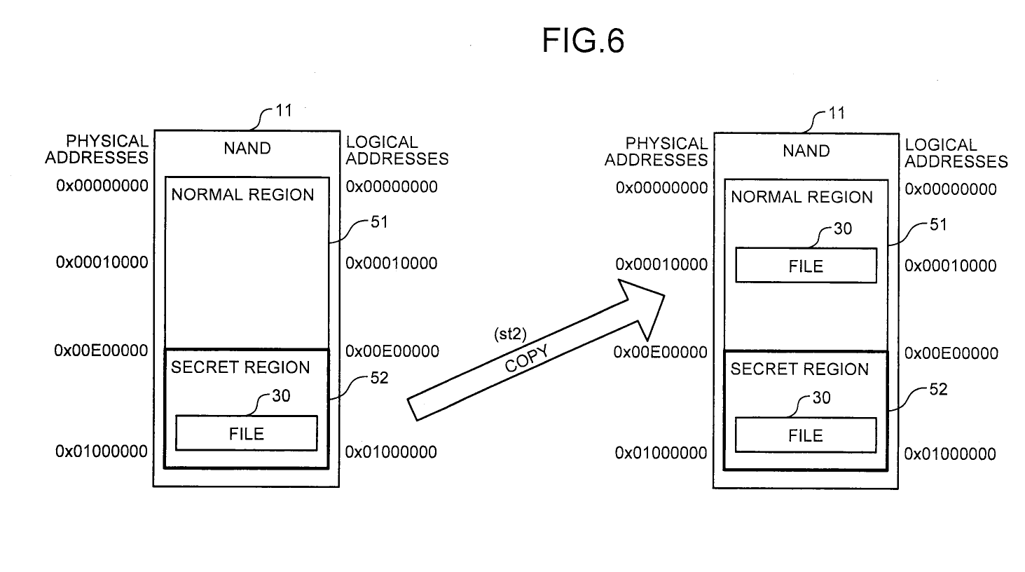

FIG. 6 is a diagram for describing processing of copying a file to a normal region. When next the memory card 1 is started (re-started) (when next the power is supplied to the sub CPU 10), the memory card 1 copies the file 30 in the region 52 to the normal region 51. At this point, the host CPU 21 cannot recognize the normal region 51, and thus the host CPU 21 cannot access the normal region 51.

The memory card 1 is re-started when the memory card 1 executes the OFF/ON operations of a detection signal according to an instruction form the sub CPU 10, for example. Note that the memory card 1 is also re-started when the memory card 1 is removed from the digital camera 2 by the user and is then inserted to the digital camera 2.

The file 30 in the secret region 52 is copied to the normal region 51 by the sub CPU 10. At this time, the file 30 is physically copied within the NAND 11 (st2).

For example, when physical addresses of the normal region 51 are 0x00000000 to 0x00E00000, and physical addresses of the secret region 52 are 0x00E00000 to 0x01000000, the file 30 in the secret region 52 is copied to an available physical address in the normal region 51. For example, when a physical address of 0x00010000 in the normal region 51 is available, the file 30 in the secret region 52 is copied to the physical address of 0x00010000.

In this case, a logical address of the file 30 is maintained. Therefore, in a case where the physical address “0x00E10000” before the file 30 is copied corresponds to a logical address “0x00010000”, when the file 30 is copied to the physical address “0x00010000”, the logical address of the file 30 after copy becomes “0x00010000”. In the logical/physical table, the physical address corresponding to the logical address “0x00010000” is changed from “0x00E10000” to “0x00010000”.

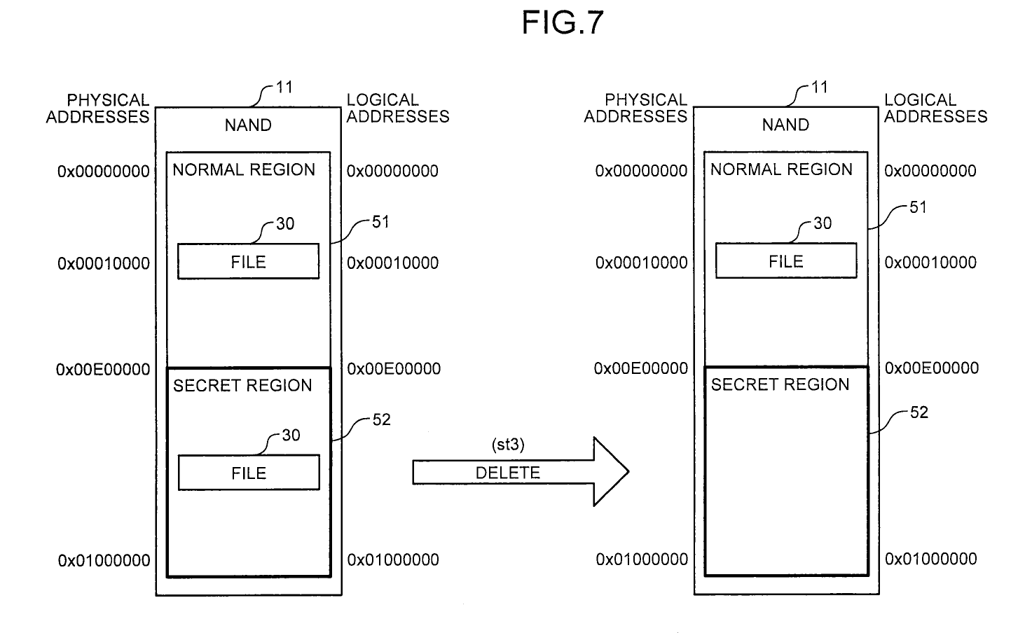

FIG. 7 is a diagram for describing processing of deleting a file in a secret region. After the file 30 in the secret region 52 is copied to the normal region 51, the file 30 is deleted from the secret region 52 (st3).

For example, when physical addresses of the secret region 52 are 0x00E00000 to 0x01000000, data disappears in the physical addresses “0x00E00000 to 0x01000000” in the secret region 52 by deletion of the file 30. In this case, the correspondence relationship between the logical address and the physical address in the NAND 11 is maintained.

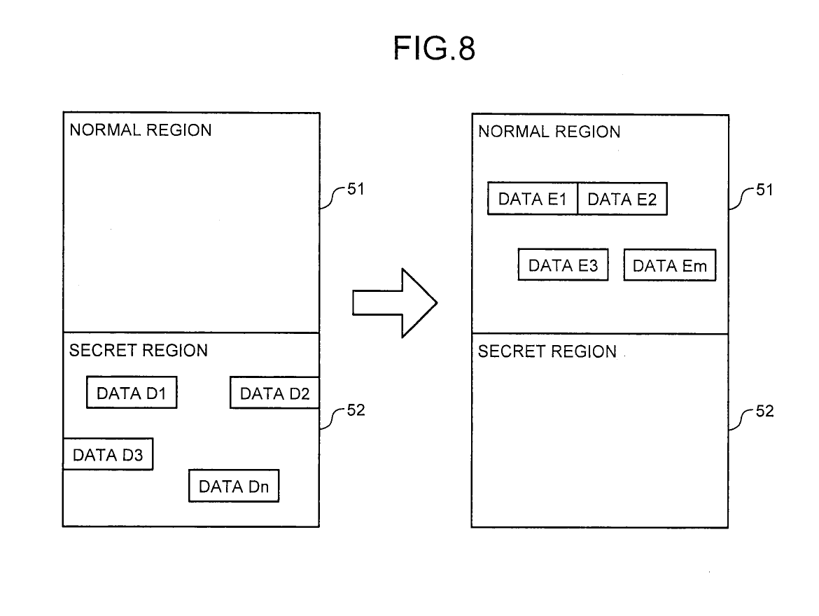

By the way, there is a case in which the file 30 is divided and stored in the normal region 51 or in the secret region 52, in the logical address sense. FIG. 8 is a diagram for describing a file configuration example in a normal region and a secret region.

For example, when the file 30 is divided into n data (n is an integer) and the n data are stored in the secret region 52, n data D1 to Dn are stored in the secret region 52. Further, when the file 30 is divided into m data (m is an integer) and the m data are stored in the normal region 51, m data E1 to Em are stored in the normal region 51. For example, the file 30 stored in the secret region 52 as the data D1 to Dn is copied in the normal region 51 as the data E1 to Em.

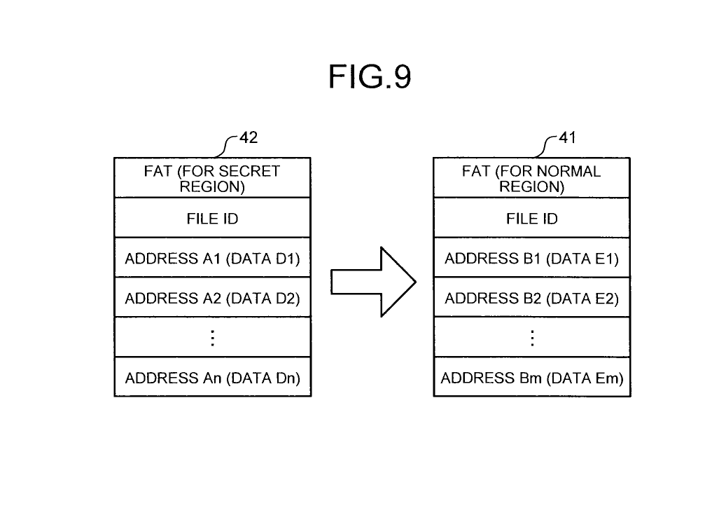

Even in such a case, the data E1 to Em in the normal region 51 and the data D1 to Dn in the secret region 52 are managed using FATs. FIG. 9 is a diagram for describing the FATs. FIG. 9 illustrates a FAT 41 for managing the data E1 to Em and an FAT 42 for managing the data D1 to Dn, illustrated in FIG. 8.

The FAT of the present embodiment includes the FAT 41 for the normal region 51 and the FAT 42 for the secret region 52. The FAT 41 for the normal region 51 is stored in the FAT region 81 in the normal region 51. Further, the FAT 42 for the secret region 52 is stored in the FAT region 83 in the secret region 52. In the FATs 41 and 42, information that identifies a file (file ID) and a logical address (for example, a cluster address) in which a file is stored are associated with each other, and the FATs 41 and 42 are then registered in the FAT regions 81 and 82.

When the file 30 is stored in the secret region 52, the address in which the file 30 is stored is registered in the FAT 42. When the file 30 is divided into the data D1 to Dn, and the data are stored in the secret region 52, n addresses (storage address range) A1 to An of the data D1 to Dn are sequentially registered in the FAT 42.

In this case, the sub CPU 10 sequentially registers the addresses A1 to An in the FAT 42 so as to restore the file 30 by sequentially tracing back the addresses A1 to An. In the FAT 42, a location (pointer) in which an address A (x+1) of data D (x+1) is stored is stored, together with an address Ax of data Dx (x=1 to (n−1)).

Further, when the file 30 is stored in the normal region 51, an address in which the file 30 is stored is registered in the FAT 41. When the file 30 is divided into the data E1 to En, and the data are stored in the normal region 51, m addresses (storage address range) B1 to Bm of the data E1 to Em are sequentially registered in the FAT 41.

In this case, the sub CPU 10 sequentially registers the addresses B1 to Bm in the FAT 41 so as to restore the file 30 by sequentially tracing back the addresses B1 to Bm. In the FAT 41, for example, a location (pointer) in which an address B (y+1) of data D (y+1) is stored is stored, together with an address By of data Dy (y=1 to (m−1)).

When the file 30 has been copied from the secret region 52 to the normal region 51, the sub CPU 10 registers, in the FAT 41, the addresses of the file 30 (the data E1 to Em) and the file ID stored in the normal region 51. Further, when the file 30 has been deleted from the secret region 52, the sub CPU 10 deletes, from the FAT 42, the addresses and the file ID of the file 30 (the data D1 to Dn) that has been deleted from the secret region 52.

Note that, in the present embodiment, a case in which the sub CPU 10 executes the OFF/ON operations of a detection signal has been described. However, the sub CPU 10 may execute the OFF/ON operations of the power supplied to the memory card 1 instead of the OFF/ON operations of a detection signal.

When the host CPU 21 becomes able to access the normal region 51, the host CPU 21 also becomes able to access the FAT 41. Therefore, the host CPU 21 becomes able to access the file 30 in the normal region 51 based on the FAT 41.

As described above, in the present embodiment, the file 30 written from the digital camera 2 is temporarily stored in the secret region 52 that cannot be viewed from the host CPU 21. Then, when next the memory card 1 is started, the temporarily stored file 30 is transferred from the secret region 52 to the normal region 51 before the host CPU 21 recognizes the normal region 51. Following that, the host CPU 21 is allowed to recognize the normal region 51

As a result, when both of the sub CPU 10 and the host CPU 21 access the NAND 11, writing data from the sub CPU 10 to the NAND 11 becomes possible without changing access processing from the host CPU 21 to the NAND 11.

As described above, according to the embodiment, the file system can be updated without requiring special processing by the host CPU 21, and without causing inconsistency in the file system held by the host CPU 21.

As described above, processing change of the host CPU 21 is not necessary, and thus even if an existing product is used as the host CPU 21, the writing function from the sub CPU 10 to the NAND 11 can be used.

Further, completion of reception is notified to the user after reception of a new file 30 is completed by the memory card 1, and thus the user can easily recognize update of the file system.

Further, the timing at which the power is supplied to the sub CPU 10 after the file 30 is uploaded to the memory card 1 is a timing at which removal and insertion of the memory card 1 occurs. In the present embodiment, the memory card 1 voluntarily performs the operation corresponding to the removal and insertion of the memory card 1, whereby the above-described processing of steps S20 to S60 can be automatically executed.

While embodiments of the present invention have been described, these embodiments are exemplarily presented, and it is not intended to limit the scope of the invention. These new embodiments can be implemented in various other forms, and various omissions, replacements, and changes can be performed without departing from the gist of the invention. These embodiments and modifications are included in the scope and the gist of the invention, and are also included in the scope of the invention described in claims and its equivalents.

For example, in the embodiment of the present invention, a case in which the physical addresses of the normal region 51 are 0x00000000 to 0x00E00000, and the physical addresses of the secret region 52 are 0x00E00000 to 0x01000000 has been exemplarily described, and the normal region 51 and the secret region 52 are defined using the physical addresses. However, the normal region 51 and the secret region 52 may be defined using logical addresses.

Further, in the embodiment of the present invention, when the file 30 is copied from the secret region 52 to the normal region 51, the file 30 is copied from the physical address allocated to the secret region 52 to the physical address allocated to the normal region 51. However, the file 30 is not copied to a different physical address, and a logical address corresponding to the physical address in which the file 30 is stored may be changed from the logical address allocated to the secret region 52 to a different logical address allocated to the normal region 51.

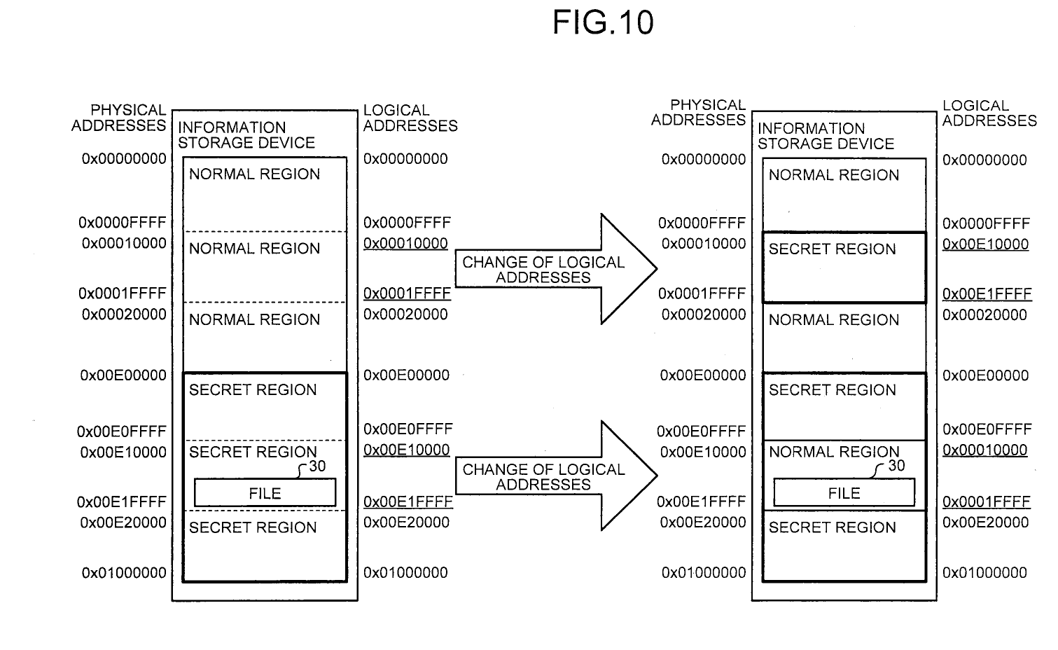

FIG. 10 is a diagram for describing processing of copying a file using processing of changing logical addresses. For example, when the logical addresses of the normal region 51 are 0x00000000 to 0x00E00000, and the logical addresses of the secret region 52 are 0x00E00000 to 0x01000000, the logical addresses of 0x00E10000 to 0x00E1FFFF are changed to 0x00010000 to 0x0001FFFF without performing physical copy of the file 30. Note that 0x00010000 to 0x001FFFF that are the logical addresses of the normal region 51 are changed to 0x00E10000 to 0x00E1FFFF with the change of the logical addresses. Accordingly, the processing of copying the file 30 (transfer processing) using the processing of changing the logical addresses is executed.

Further, allocation of the normal region 51 and the secret region 52 with respect to the logical addresses or the physical addresses may be changed so that a region in which the logical address or the physical address of the file 30 is included is changed from the secret region 52 to the normal region 51 without changing the logical address and the physical address.

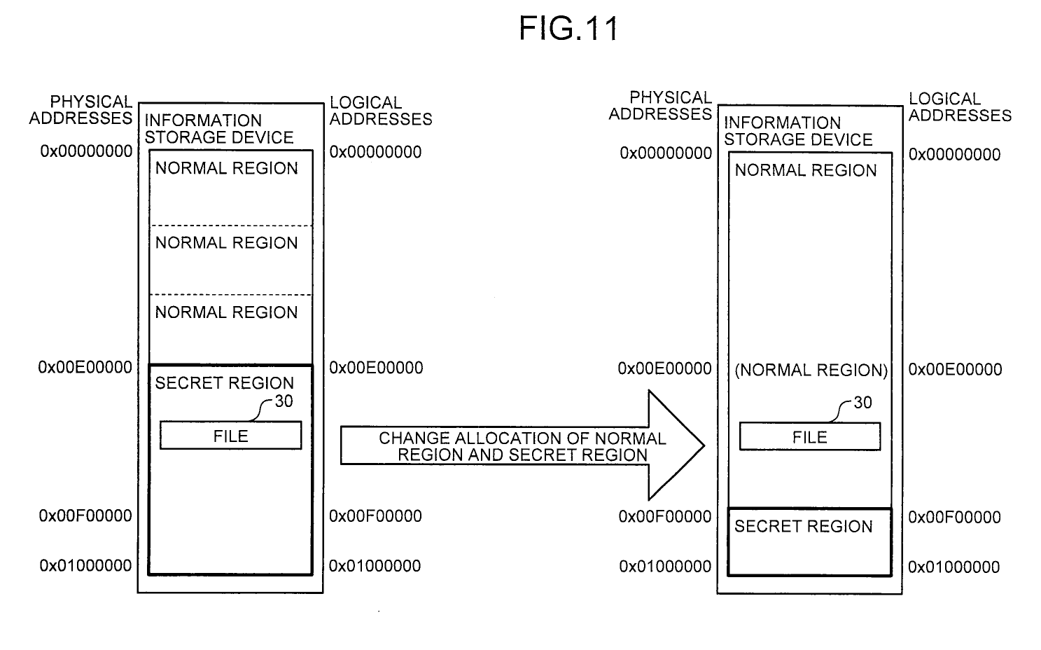

FIG. 11 is a diagram for describing processing of copying a file using processing of changing allocation of a normal region and a secret region. For example, when the physical addresses of the normal region 51 are 0x00000000 to 0x00E00000, and the physical addresses of the secret region 52 are 0x00E00000 to 0x01000000, the file 30 stored in the physical address 0x00E10000 is transferred from the secret region 52 to the normal region 51 by changing the physical addresses of the normal region 51 to 0x00F00000 to 0x01000000. Note that the physical addresses of the secret region 52 are changed from 0x00E00000 to 0x0100000 to 0x00F00000 to 0x0100000 with the change of the physical addresses. Accordingly, the processing of copying the file 30 (transfer processing) using the processing of changing allocation of the normal region 51 and the secret region 52 is executed.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An access control method comprising the steps of:
writing, by a first arithmetic unit, a file to a first non-volatile storage region accessible by the first arithmetic unit and inaccessible by a second arithmetic unit;
when the first arithmetic unit is started next time, copying, by the first arithmetic unit, the file from the first non-volatile storage region to a second non-volatile storage region before the second arithmetic unit recognizes the second non-volatile storage region; and
recognizing, by the second arithmetic unit, the second non-volatile storage region after the copying.

2. The access control method according to claim 1, wherein the first and the second non-volatile storage regions are allocated inside a single storage region, and which of the first and the second non-volatile storage regions a physical address in the single storage region belongs to is managed by a management table that manages data in the single storage region, and
the first arithmetic unit
changes the file in the single storage region from a state of belonging to the first non-volatile storage region to a state of belonging to the second non-volatile storage region by changing the management table when the first arithmetic unit copies the file from the first non-volatile storage region to the second non-volatile storage region.

3. The access control method according to claim 1, wherein the first arithmetic unit controls switching of recognizing of the second non-volatile storage region by the second arithmetic unit, and not recognizing of the second non-volatile storage region by the second arithmetic unit.

4. The access control method according to claim 3, wherein the first arithmetic unit causes the second arithmetic unit not to recognize the second non-volatile storage region until processing of copying the file from the first non-volatile storage region to the second non-volatile storage region is completed.

5. The access control method according to claim 1, wherein,
when the first arithmetic unit writes the file in the first non-volatile storage region, the first arithmetic unit notifies a user of a processing state of the writing using at least one of light, a vibration, and a sound.

6. The access control method according to claim 5, wherein the first arithmetic unit
notifies the user of completion of the writing the file.

7. The access control method according to claim 5, wherein the first arithmetic unit
notifies the user of during the writing the file.

8. The access control method according to claim 1, wherein the first arithmetic unit,
by executing an operation to turn OFF and an operation to turn ON a detection signal used by the second arithmetic unit to detect a first device including the first arithmetic unit has been connected to a second device including the second arithmetic unit after writing the file in the first non-volatile storage region, causes a state of connection to be a state that is the same as a state in which the first device is removed from the second device and is re-connected to the second device.

9. The access control method according to claim 8, wherein the first arithmetic unit
executes the operation to turn OFF the detection signal and the operation to turn ON the detection signal by executing cut-off and connection of power supplied to the first device.

10. The access control method according to claim 8, wherein the first arithmetic unit
executes the operation to turn OFF the detection signal and the operation to turn ON the detection signal by mechanically turning OFF and ON a switch included in the first device.

11. A data storage device comprising:
a first arithmetic unit;
a first non-volatile storage region accessible by the first arithmetic unit, and inaccessible by a second arithmetic unit included in another device; and
a second non-volatile storage region accessible by the first arithmetic unit, and accessible by the second arithmetic unit when having been recognized by the second arithmetic unit,
wherein the first arithmetic unit writes a file in the first non-volatile storage region,
when the first arithmetic unit is started next time, the first arithmetic unit copies the file from the first non-volatile storage region to the second non-volatile storage region before the second arithmetic unit recognizes the second non-volatile storage region, and
the second arithmetic unit recognizes the second non-volatile storage region after the copy.

12. The data storage device according to claim 11, further comprising:
a single storage region including the first and the second non-volatile storage region; and
a management table configured to manage data in the single storage region, and to manage which of the first and the second non-volatile storage regions a physical address in the single storage region belongs to,
wherein the first arithmetic unit
changes the file in the single storage region from a state of belonging to the first non-volatile storage region to a state of belonging to the second non-volatile storage region by changing the management table when the first arithmetic unit copies the file from the first non-volatile storage region to the second non-volatile storage region.

13. The data storage device according to claim 11, wherein the first arithmetic unit controls switching of recognizing of the second non-volatile storage region by the second arithmetic unit, and not recognizing of the second non-volatile storage region by the second arithmetic unit.

14. The data storage device according to claim 13, wherein the first arithmetic unit causes the second arithmetic unit not to recognize the second non-volatile storage region until processing of copying the file from the first non-volatile storage region to the second non-volatile storage region is completed.

15. The data storage device according to claim 11, further comprising:
a notification unit configured to notify, when the file is written in the first non-volatile storage region, a user of a processing state of the writing according to an instruction from the first arithmetic unit,
wherein the notification unit notifies the user of the processing state of the writing using at least one of light, a vibration, and a sound.

16. The data storage device according to claim 15, wherein the notification unit
notifies the user of completion of the writing the file.

17. The data storage device according to claim 15, wherein the notification unit
notifies the user of during the writing the file.

18. The data storage device according to claim 11, wherein the first arithmetic unit,
by executing an operation to turn OFF and an operation to turn ON a detection signal used by the second arithmetic unit to detect a first device including the first arithmetic unit has been connected to a second device including the second arithmetic unit after writing the file in the first non-volatile storage region, causes a state of connection to be a state that is the same as a state in which the first device is removed from the second device and is re-connected to the second device.

19. The data storage device according to claim 18, wherein the first arithmetic unit
executes the operation to turn OFF the detection signal and the operation to turn ON the detection signal by executing cut-off and connection of power supplied to the first device.

20. The data storage device according to claim 18, wherein the first arithmetic unit
executes the operation to turn OFF the detection signal and the operation to turn ON the detection signal by mechanically turning OFF and ON a switch included in the first device.
